(19) United States
(12) Patent Application Publication
(10) Pub. No.: US 2005/0132404 A1
(43) Pub. Date: Jun. 16, 2005

(54) Method and system for rapid point-of-sale creation of video products

(76) Inventor: Mitchell Burnside Clapp, Los Olivos, CA (US)

Correspondence Address: THE HECKER LAW GROUP, 1925 CENTURY PARK EAST, SUITE 2300, LOS ANGELES, CA, 90067, US

(21) Appl. No.: 10/734,950

(22) Filed: Dec. 12, 2003

(51) Int. Cl. H04N 7/16; H04N 5/445; G06F 3/00

(52) U.S. Cl. 725/60; 725/1; 705/26; 705/27

(57) ABSTRACT

A method and system for producing video products at a point-of-sale in a retail-reasonable time is described. The system comprises a Selection Interface, Purchase Station, and Command Center. The Selection Interface allows customers access to a catalog of available products. The system includes storage for a complete video product catalog at each retail location, thereby improving the time-to-customer over systems which download product selections after purchase. The Purchase Station catalog may be periodically updated with new products which may be pushed from a Command Center. Sales and marketing information may be communicated back to the Command Center. This system supports a method which requires minimal retail space requirements and provides maximum product catalog capacity. The method of the present invention allows small retail locations to tap into the secondary video market with minimal floor space requirements and provides consumers with a large variety of reasonably priced video products.

### BACKGROUND OF THE INVENTION

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights.

A. Field of Invention

This invention relates to the field of methods of doing business and, more specifically, to a method and system for rapid point-of-sale creation of video products.

B. Background Art

With the advancement of computer technology and the substantial reduction in the price of microprocessors and computers, it is now economically feasible to integrate computer systems into many retail processes. The present invention utilizes such integration in a novel context to overcome problems and limitations in the retail video rental industry, such as the cost and space requirements of operating a retail video rental outlet. Those problems and limitations are discussed in more detail below.

A current typical retail video rental outlet store maintains an inventory of products such as VHS (Video Home System) tapes, DVD (Digital Video Disk, a.k.a. Digital Versatile Disk) disks, and video game cartridges, or other entertainment products available for rental in the retail marketplace. For simplicity the term “video product” will be used herein to represent these types of products and is intended to apply to any and all entertainment products commonly rented or sold at retail outlets.

Presently, in a typical rental scenario customers may obtain a “membership” card or other identification means which links a video product rental to a credit card. This link provides the retailer a revenue source as collateral for the video products. A customer might enter the retailer's storefront location, browse shelves of video tapes and DVDs, select one or more products, take those product selections to the checkout stand, and pay a rental fee to rent the selections for a fixed period of time. The customer then, for example, takes the selections home for private use (e.g., viewing, playing, etc.), and then returns the product to the retail outlet within the time allowed by the rental agreement. If the customer fails to return the product, or returns it late, the retailer bills the customer's credit card excess fees, or in some cases for the replacement cost of the missing product. The retailer may maintain a record of the customer's rentals at the retailer's discretion.

Some rental outlets guarantee that certain selections will be available in the store, requiring retailers to stock many copies of some popular video products. Retail outlets further require the expense of inventory management and customer support staff. Staff must be sufficient to process transactions, answer questions, manage worn and damaged products, stock and restock shelves and otherwise maintain the retail operation. Many such retailers operate 24 hours a day, seven days a week, further increasing the staffing needs and costs of the business. While the advent of DVD technology has reduced the inventory space required for a retail rental outlet, product costs are greater. Also, mechanisms to prevent shoplifting are expensive to employ.

In current retail outlets shelf space and inventory storage can also be problematic. For example, to increase return on investment many retail outlets sell used products at a discount. The sale of used products places further demand on limited shelf space and staff support, and reduces the available inventory of older products.

From the customer's point of view retail rental of video products is both advantageous and disadvantageous. Having a video product available for use when and where a customer desires, without the cost of purchase, is a primary attraction of video product rentals. Often a consumer's interest in the product may be time limited. Perhaps a single use of a given video product would render it obsolete to a customer. The desire to see a movie once may not justify, in the consumer's mind, the price of outright purchase. Rental of a product at a price much less than the cost of purchase is an attractive alternative.

One problem with retail rental of video products is that product selection is often limited. Therefore, the desired product is not always available at a given rental outlet. For example, typical rental outlets often carry many copies of popular products, due to advertised availability guarantees, thereby greatly reducing the inventory space available for less frequently rented items. Identifying and locating a product that is not currently popular is also a challenge for customers and staff alike. Customers are sometime referred to large paper catalogs in the store to fend for themselves in finding the title of a product they wish to rent. A further disadvantage in the typical rental scheme is the requirement to return the rented item when the rental period expires, necessitating a possibly inconvenient trip to the rental outlet. For the retailer, returns entail costs for product examination, rewinding, re-shelving and other inventory management costs.

Rental price is another disadvantage of the typical rental scheme. While DVDs have increased the quality of the product now available for rental the DVD format has also increased the cost of rentals, as the retail outlet attempts to recoup its ROI (return on investment) for the much more expensive DVD product. Inventory management is labor intensive, which keeps up price pressure on the rental product. Further, retail rental outlets must compete with pay-per-view movies available on cable and satellite subscription services and download rental services, which offer multiple showings per day of the latest releases, often at prices comparable to rental prices. Such pay-per-view schemes do not have the disadvantage of requiring multiple trips to a retail outlet. Pay-per-view therefore also increases price pressure on retail outlets. Further, retail outlets must compete with home delivery schemes where customers order video product rentals via the Internet or by mail for home delivery. Finally, various World Wide Web (WWW) based models permit users to download movies to home computers for viewing within a 24 hour period, after which time the download expires. While such systems are beginning to gain popularity they are of limited appeal because they require hours to download a movie, require an Internet connection to play the movie, and require that the movie be played back on a computer. All these approaches, and others, add price pressure to the present retail rental business model.

For the foregoing reasons, a need exists for a video rental method and system that can overcome the disadvantages described above.

### SUMMARY OF THE INVENTION

A method and system for rapid point-of-sale creation of video products is described. In embodiments of the invention, a customer selects a video product for rental. The video product is produced and delivered to the consumer in retail-reasonable time, using a minimum of retail space and at greatly reduced expense to the retailer.

In one or more embodiments of the invention, a consumer selects a video product from an electronic product catalog. The product is then “burned” onto a CDROM while the customer waits. Indicia of the transaction is created and interspersed in the product at creation to protect the intellectual property interests of the product producers.

The quality of the video product may be sufficient to allow the customer to enjoy the product and to allow for product creation in a “retail reasonable” time frame. The customer may pay a “video rental” price for the product, and take the product home to play in any existing player device. The customer may not be required to return the product to the retail outlet. This method may be accomplished without maintaining a physical inventory of VHS or DVD products, allowing the business of retail video product rental to occur from most existing retail storefront businesses. The model of the present invention can increase sales and profit from businesses as diverse as gas stations, convenience stores, video arcades, supermarkets, beauty salons or almost any retail location. Floor space, staff and training are minimal, making the business model of the present invention an accessible addition to most existing retail businesses.

In alternative embodiments of the invention the customer may purchase directly from the Internet via a web browser interface. The consumer can then either pick up the product at a designated retail location or create the product directly on a home computer, for example with a home computer with CDROM burner.

Finally, indicia of the transaction may be written into the video product such that, if the product is later copied or redistributed, the indicia will identify the purchaser of the product, providing for enforcement of intellectual property rights.

### BRIEF DESCRIPTION OF THE DRAWINGS

FIG. 1 illustrates a transaction method, according to one or more embodiments of the invention.

FIG. 2 illustrates various units and interfaces of a system of the invention, according to one or more embodiments of the invention.

FIG. 3 is a flow diagram illustrating a purchase transaction flow in accordance with one or more embodiments of the invention.

FIG. 4 is a flow diagram illustrating the catalog server update flow, according to one or more embodiments of the invention.

FIG. 5 is a flow diagram illustrating cash flow and accounting, according to one or more embodiments of the invention.

### DETAILED DESCRIPTION OF THE INVENTION

The invention provides a method and system for rapid point-of-sale creation of video products. In the following description, numerous specific details are set forth in order to provide a thorough understanding of the present invention. It will be apparent, however, to one skilled in the art that the present invention may be practiced without these specific details. For example, while the present method is described in terms of a single retail location it will be apparent to one of skill in the art that the selection interface may be located remotely from the purchase station. Therefore, for clarity of description, the various units and interfaces of the invention are described as located and connected via one particular embodiment of the method of the invention, but this is by way of example only. It will be understood by one of ordinary skill in the art that this invention is similarly applicable to other interfaces, such as an Internet-based selection interface. Further, in some instances well-known features of the invention have not been described in detail so not to unnecessarily obscure the present invention.

In one embodiment of the method of the invention, a user enters a retail establishment that contains an embodiment of the system of the invention. Such an establishment could be any form of retail business, from a newsstand or gas station to a warehouse superstore. The retail business might only need to provide room for at least one Selection Unit, at least one Purchase Station, and at least one Retail Interface Station of the present invention.

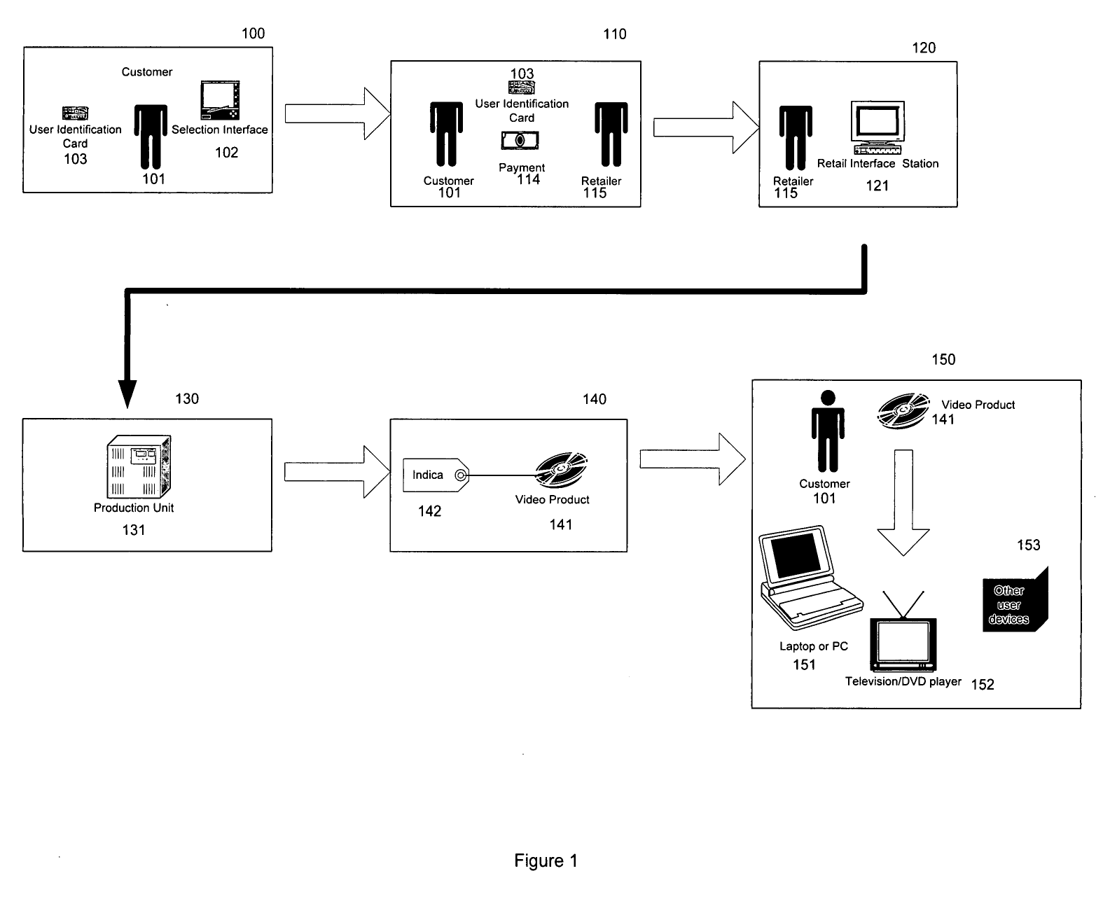

FIG. 1 illustrates a transaction, according to one or more embodiments of the method of the invention. Customer 101 interacts with the Selection Interface Unit 102 as in step 100 to select a video product for purchase. Selection Unit 102 of the present invention may support multiple and alternative methods of product selection. For example, a customer may search by actor, director, producer, or combinations thereof. Title or partial title, genre, date released, or any other criteria by which a customer might want to select a film are other possible search criteria. The product catalog may also be browsable. After identification of at least one product, the customer may use the interface of the selection unit to select the product for creation.

At step 110, Customer 101 approaches Retailer 115 to purchase the selection. Retailer 115 may be a self-service or staffed “checkout” stand, a stand-alone device, or a staffed Retail Interface Station 121 (which in some embodiments may be part of or distinct from the selection unit) to obtain the selected product. At step 120, Customer 101 or Retailer 115 enables Production Unit 131 to create Video Product 141. In some embodiments of the invention Customer 101 may be required to present a form of identification 103 known to the system of the invention, such as a membership card or user id and password, to obtain the retail product. At step 130, Video Product 141 is created by Production Unit 131. In one or more embodiments of the invention, creation of Video Product 141 may comprise burning a CDROM with video data.

Video Product 141 is created by Production Unit 131 in “retail reasonable time”. “Retail reasonable time” is the amount of time a typical customer is willing to wait at a retail location for the selected product to be created. An amount of time beyond which a typical customer would grow impatient and abandon the transaction (e.g., walk away) is not a “retail reasonable” amount of time. In one embodiment of the present invention the product may be created in about a minute. This is a “reasonable” time for most customers to wait for a custom-produced product. Times longer than one minute may be acceptable for some embodiments of the invention. “Retail reasonable” time may vary by type of retail location, number of products selected, price per product and other determinable characteristics of the transaction which are understandable to those of skill in the art.

Creating a CDROM (CD) of a video product may be done by various means well known to those of skill in the art. In one embodiment of the invention creating a CD of a video product of a feature length film in about a minute is done by creating the file on the CD using MPEG1 format. MPEG1 is a compression format that compresses 7.7 MB down to about 150 KB, providing a resolution of 352×240 pixels at 30 frames per second. Those of ordinary skill in the art are aware that many alternative formats for video are available which can store a feature length motion picture in a file that will fit on a CD, and many of those formats will allow creation of the CD in “retail reasonable” time. The method of the present invention encompasses utilizing any video format that permits, for example, 180 minutes of video to reside in a file of no greater than 650 MB. The means for creating a CD containing a video file is well known to those of skill in the art and therefore is not described herein.

Step 140 illustrates that, during creation of the CD, indicia of the purchase may be added pervasively throughout Video Product 141. In one or more embodiments of the invention, Transaction Indicia 142 may include the date and time of purchase, retail location, customer identification, or other indicia which may be retail location dependent. Such indicia may be included with the video product to discourage and enforce copyrights and other intellectual property rights of the video product. Selection of data to include in Transaction Indicia 142 will vary with different embodiments of the invention. In some embodiments of the invention minimum indicia will be stored to ensure intellectual property rights while providing the purchaser with anonymity in the transaction. Such anonymity may be important to encourage the sale of some types of video products, such as adult entertainment.

Step 150 of the present invention illustrates that Video Product 141 may be used by Customer 101 in any compatible display device. Examples of compatible devices include laptop computer 151, DVD players which connect to televisions, television 152 equipped to play CDs directly, personal DVD players such as those designed for airline travel, or any other device 153 which can play a CD containing a video file. Video Product 141 produced by the method of the present invention is not limited to displaying on a computer, and does not require a device with an Internet connection to display the product.

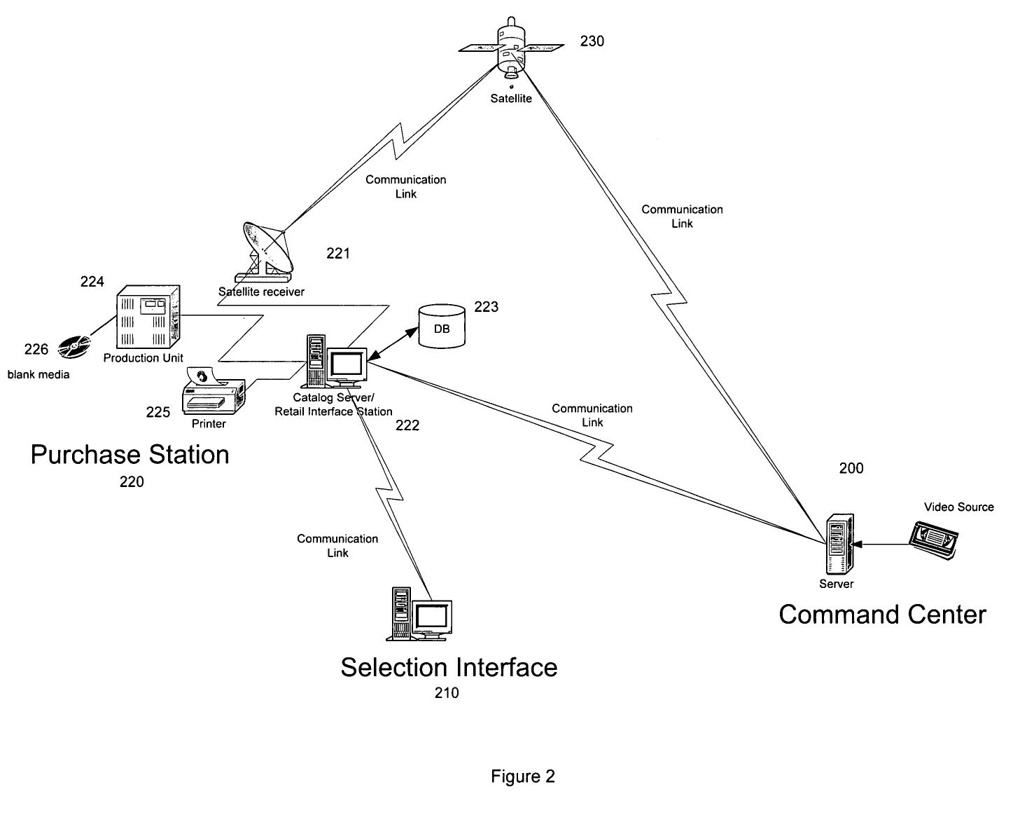

The system of the present invention includes a plurality of units for performing the method of the invention, some of which were described above. FIG. 2 illustrates the various units and some of the interfaces of the system of the invention, according to one or more embodiments of the invention. Command Center 200 has the ability to creating digital files from both analog and/or digital video product sources, such as, for example, VHS tapes, film, and digital motion picture files. The video product files can be created, compressed, encrypted and stored at Command Center 200. Command Center 200 may also centralize accounting, intellectual property rights management, storage of purchase indicia, and creation of product catalog information for the system of the present invention. Video product files may be distributed to one or more Production Units 224 via any convenient form of communication. The present invention encompasses many means of providing video product files to the retailer. For example, in one embodiment of the invention, video product files may be broadcast on encrypted satellite television channels. Such channels may be leased from commercial satellite TV providers or dedicated to the system of the present invention. Alternative embodiments of the invention encompass burning files to computer disks which are then shipped to the retailer. Alternatively files may be transferred electronically via the Internet, a WAN (Wide Area Network), a LAN (Local Area Network) or a VPN (Virtual Private Network). The present invention envisions using these and other alternative means of providing retailers with video product files, as alternative methods of providing products increase the reliability of the system.

The system of the present invention also may include Selection Interface 210. Selection Interface 210 may be a computer, a kiosk, or other form of interface unit. Selection Interface 210 encompasses a means for displaying the video product, displaying and searching the product catalog, and a means for selecting one or more products for purchase.

Purchase Station 220 consists of one or more computer units capable of providing the retailer an interface to the system of the present invention. In one embodiment of the invention Purchase Station 220 consists of a Retail Interface Station to facilitate retailer authorization of purchases selected by the customer. The optional authorization step allows prevention of undesirable creation of video products, such as selections for which the customer cannot pay. In different embodiments of the invention Retail Interface Station 222 may or may not share the same computing device as the Catalog Server. For ease of discussion, an embodiment where the two functions share a physical device (unit 222 of FIG. 2) is described herein and referred to interchangeably, but one of ordinary skill in the art will recognize that either configuration is within the scope of this invention. In installations where there may be a plurality of Selection Interface stations, Catalog Server 222 provides a central database of product information. Purchase Station 220 may also include printer 225 for printing CD labels, receipts, reports and other records for the present invention. Production Unit 224 may be included to increase the output capacity of the system. Production Unit 224 may contain one or more CD ROM burners which operate simultaneously to ensure the production time for the video products remains “retail reasonable.” Purchase Station 220 may also include Satellite Receiver 221 for receipt of encrypted satellite download of new products from Command Center 200. Purchase Station 220 also comprises blank media 226 for creation of video products.

Elements of the system of the present invention may be combined into single units, such as Purchase Station 220 and Production Unit 224. While Catalog Server 223 may be combined with Production Unit 224, or may be a separate system, the physical “footprint” will be reduced if these elements are combined into a single computer unit.

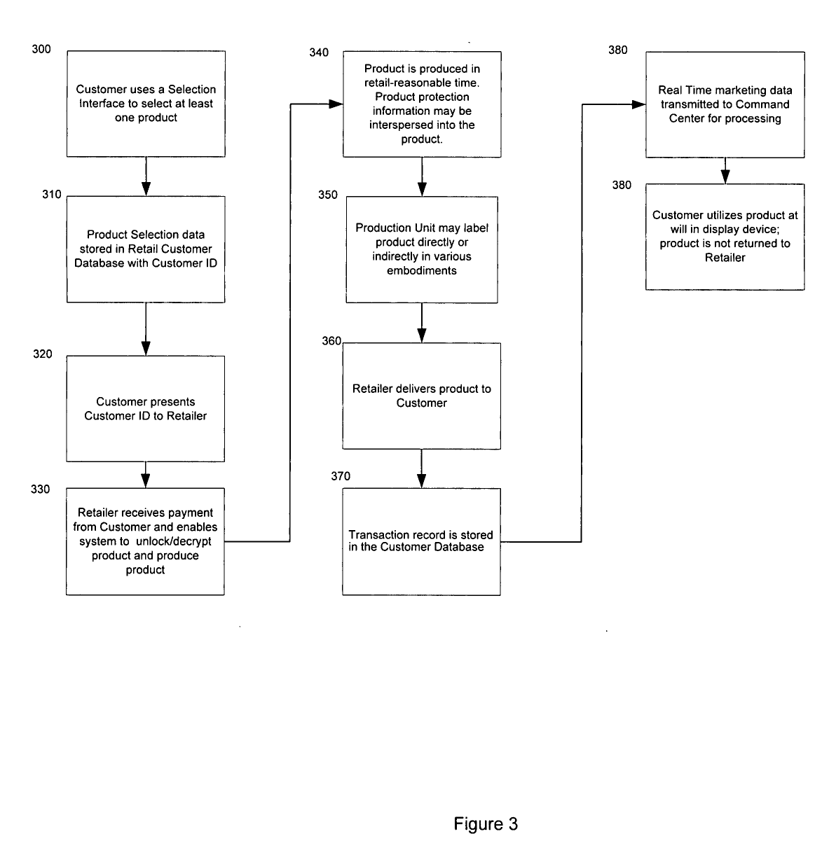

FIG. 3 illustrates the purchase transaction flow in accordance with one or more embodiments of the invention. At step 300, a customer utilizes Selection Interface 210 to select at least one video product for purchase. A single customer transaction may, of course, include multiple selections. In fact, Selection Interface 210 may easily be programmed to suggest additional selections to the customer based on current popular selections, new releases, other compatible selections, or any other criteria familiar to those of skill in the marketing arts which may lead to increased sales for a given transaction. Following the customer's selection of at least one product, Selection Interface 210 communicates the selection data to Retail Customer Database 223, using a Customer ID or other unique indicator to associate the selection with the customer. Selection data may indicate selection, quality, format, or other information chosen by the customer at Selection Interface 210. If special pricing offers are incorporated in the system, for example discounts for multiple purchases or special prices for frequent buyers, then pricing information may also be communicated from Selection Interface 210 to the Retail Interface Station 222.

Information communicated from Selection Interface 210 to Retail Interface Station 222 may be stored in a temporary record, as its retention is not required if the customer's purchase is never completed. Retail Interface Station 222 may flush all uncompleted transactions at a proscribed time, such as closing, or on demand. Uncompleted transactions may expire, or be stored for future use by the customer, such as in a wish-list or registry type scenario familiar to those of skill in the art.

When the customer wishes to complete the transaction and acquire the selected product or products, the customer presents a customer ID to the retailer at step 320. The retailer may configure the system of the present invention to produce the video product upon completion of selection, upon payment, upon retailer direction, or by remote command if available. Step 330 illustrates an embodiment where a customer presents payment to a retailer, who uses Retail Interface Station 222 to cause Production Unit 224 to produce the customer's selections.

Production Unit 224 creates the video product or products using a format that supports creation in retail-reasonable time. In various embodiments of the present invention different formats are offered to the customer. Format selection may effect price and creation time of the selection. To ensure service to a reasonable number of customers at a time, some retail outlets may have multiple Production Units 224. Production Unit 224 may be capable of making one or more than one video product at a time, using configuration techniques familiar to those of skill in the art. Production Unit 224 receives information from Retail Interface Station 222 required to decrypt, unlock or otherwise release the protected video product files on Catalog Server 222. During creation of the video product, protection information is encoded or otherwise interspersed into the video product at step 340. Such information may be used to trace the source of the product to aid investigations into intellectual property rights violations.

At step 350, Production Unit 224 may use Printer 225 to create a label for the video product. The product label may contain optional information such as the name of the selection, information about the selection such as release date, actors, directors, or other catalog information, selection format, a help telephone number, and copyright and other legal notices. Some information may be pre-applied to blank media 226, though such is not required by the present invention.

At step 360, the Retailer removes the video product from Production Unit 224 and delivers it to the customer. A transaction record is automatically stored in Database 223 at step 370. The transaction record aids investigations into intellectual property rights violations, royalty payment computations, accounting between Command Center 200 and the retailer, and protects the privacy of customers and selections unless otherwise required.

One innovation of the present invention is that the transaction record, or other related transactional information, may be transmitted to Command Center 200 in a real-time or near real-time time frame. Such information may be marketed by Command Center 200 to indicate sales trends of video products. Such information may be valuable to producers and distributors of video products. This information is transmitted to Command Center 200 from Retail Interface Station 222 by any communication link previously discussed.

At step 380, the customer utilizes the video product received at step 360, as discussed above under FIG. 1. In the method of the present invention, the customer need not return the product to the retailer. In a preferred embodiment of the invention, the product does not “expire”. The video product received at step 360 may operate in any compatible video product display device 150.

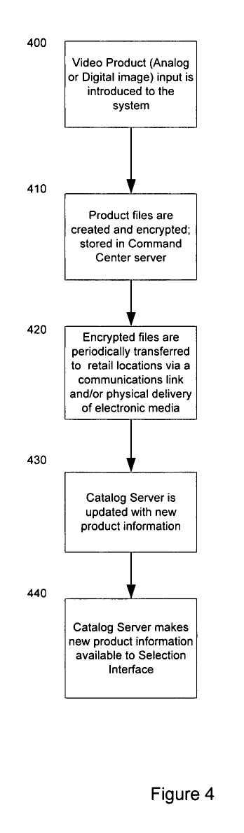

FIG. 4 illustrates the method by which Catalog Server 222 may receive video products and video product catalog information. New video products are introduced into the system of the present invention at step 400. The source product may be in analog, digital or other format known to those of skill in the art.

The video product files may be processed at Command Center 200 at step 410 such that they are “encrypted” in a format that prevents the video product from playing without prior “decrypting”. Various methods of encrypting and decrypting are well known to those of skill in the art, and are not detailed here for that reason. Any method that provides reasonable security and can be reversed in an amount of time that supports the retail-reasonable production time of the present invention may be used to secure the files on the server of Command Center 200.

Video product files may be transferred to retail locations through any and all means of communicating electronic data files at step 420. In one embodiment of the invention, a satellite may be used to communicate secured video product files from Command Center 200 to Retail Interface Station 222. A dedicated satellite transmission may be used to communicate the secured files. The dedicated transmission may be effected by leasing bandwidth, such as a dedicated channel, from a satellite television provider or any other form of dedicated or shared satellite transmission may be used. In addition to the secure video product files, catalog information may be included in the transmission. If the secured video product files are transmitted by satellite then the signal is received by satellite receiver 221 and communicated to Retail Interface Station 222, which stores the secure product files and associated catalog information on Database 223.

Alternatively secured video product files and catalog information may be transferred to Retail Interface Station 222 via any form of removable storage media known to those of skill in the art. Some examples of such media include computer disk, CDROMs, DVDs. Other alternatives include Command Center 200 sending IR equipped devices to Retailers, or using the Internet, LAN, WAN or VPN to communicate secured video product files to Retail Interface Station 222. The selection of means used to communicate product files and catalog information to Retail Interface Station 222 is not driven by time sensitive concerns, and so any and all such methods of file communication are encompassed by the present invention.

At step 430, Catalog Server 222 is updated with new catalog information reflecting newly acquired video product files. At step 440, the new catalog information goes “on line” and new products are available for retail purchase from Selection Interface 210.

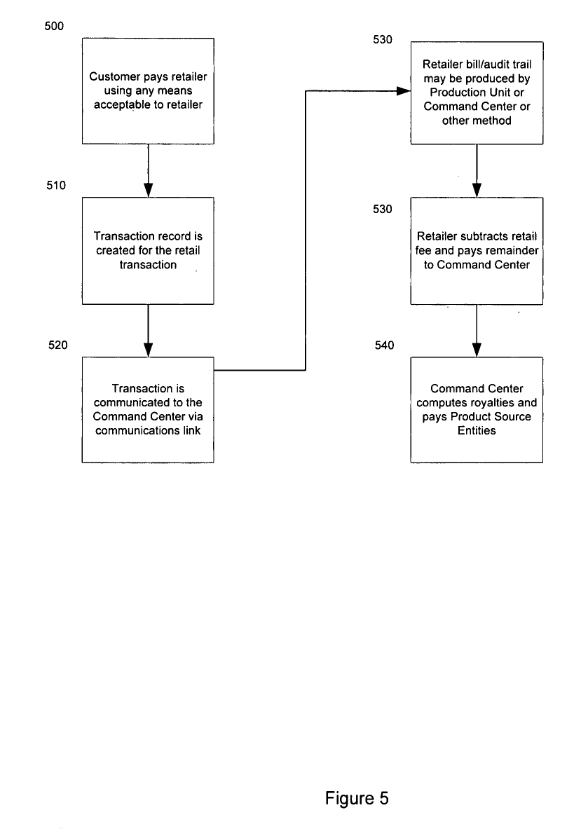

The method of the present invention includes a mechanism for cash flow and accounting in one or more embodiments of the invention, as illustrated in FIG. 5. A transaction may begin with a customer paying a retailer for one or more video products. Payment may be made at step 500 using any form of tender acceptable to the retailer. Alternatively a web-based order may be tendered with a previously established and funded account, credit card, escrow transaction means such as the popular Pay-Pal system, or other methods known to those of skill in the art.

At step 510, the system of the invention records basic information about the transaction. Because the video product is not returned to the retailer the system does not require a credit-card as collateral for the purchase, opening the system to many more customers. This creates a more anonymous transaction than those of present video product rental systems, which may attract additional sales to those customers concerned with privacy in their transactions. A transaction record may be kept for the purpose of accounting between Command Center 200 and the retailer, for the purpose of accounting for product royalties, and for accountability regarding intellectual property rights. The length of time the transaction record of step 510 is maintained by the retailer may vary in different embodiments of the invention and by retailer preference. In any case, a record of the transaction may be communicated to Command Center 200 at step 520 for at least the purposes detailed above.

The system is auditable, if desired; at step 530, the retailer and/or Command Center 200 may keep audit records and archives of transactions. Communicating transaction records to Command Center 200 may free retailers from the requirement to backup or archive transaction records. At step 530, the retailer may subtract a fee from the price collected, and forward payment to Command Center 200. At step 540, the Command Center may compute the royalties due for all products from all retail locations and forward fees for such to the holder of the royalty rights, generally the appropriate product source entities.

In another embodiment of the invention, the customer may purchase selections from a home computer using a remote interface selection unit. Such a unit could be a computer, a telephone, a wireless device or other method of connecting to the system of the invention well known to those of skill in the art. In this embodiment, the customer makes a selection as described above, but also indicates a retail pickup location for the product. So, for example, while waiting in line to pick up dry cleaning a customer could use a wireless personal data assistant (PDA) to browse the movie catalog of the invention via the Internet, then order a movie from the convenience store next door for pick-up. Due to the rapid point-of-sale creation, the product will be ready and waiting when the customer walks in the door of the retail location. It will be clear to those of skill in the art that such an embodiment of the invention is merely one embodiment of remote purchase in the method of the present invention. The invention encompasses alternative embodiments which will be clear to those of skill in the art.

The model of the present invention is an advancement in the art for consumers because it does not require a computer or Internet service in order to acquire and use the product. Video products of the invention may, for example, be used in any present DVD player. The consumer may be permitted to keep the product, which need not expire. The video product of the present invention may be played, for example, on a personal DVD player or laptop computer, making it superior in portability to downloaded movies, which require an internet connection to play.

An additional benefit of the model to consumers can be protection of customer privacy through anonymous transactions that maintain minimal information about the transaction and the purchaser. Data to protect copyrights of the video products may be maintained separately from purchaser information. In a further advancement to consumers, the present invention allows any retail outlet to maintain a vast catalog of products with advanced searching tools to assist the customer in selecting a product.

The model of the present invention is a further advancement to product producers, because while quality is sufficient for casual viewing, serious aficionados may still wish to purchase quality DVD products, preventing degradation of the DVD market for the video product. The model of the present invention may increase video rental revenue because of increased availability of video products, by virtue of increased retail outlets that can provide the product to consumers.

The model of the present invention provides an advancement to retailers because any existing retail business may participate, increasing impulse purchases by existing customers, and attracting new drop-in customers who may purchase other items, all the while requiring a minimum of floor space, staff and materials. Further advantages to the retailer include a vast catalog of products available at all times. By virtue of this catalog, retailers using the present invention may have already-available older products that may suddenly increase in demand because of current events, such as the death of a famous actor, with no costly delay involved in acquiring the now hotly desired inventory.

Thus, a method and system for rapid point of sale creation of video products have been described in conjunction with one or more specific embodiments. The invention is defined by the claims and their full scope of equivalents.

1. A method for point-of-sale production of a video product comprising:
maintaining a plurality of video products in an electronic format accessible to a retail purchase station;
receiving an input comprising a selection of at least one of said video products from a selection interface;
producing said selected video product at a point-of-sale in retail-reasonable time by creating at least one removable media comprising said selected video product; and
providing to a customer said selected video product.

2. The method of claim 1, further comprising:
storing said plurality of video products in an encrypted format accessible to said retail purchase station.

3. The method of claim 2, further comprising:
decrypting at least one of said encrypted format video product to produce said selected video product.

4. The method of claim 1, further comprising:
interspersing product protection information into said produced video product.

5. The method of claim 1, further comprising:
associating said selection with a customer identifier; and
utilizing said customer identifier in producing said selected video product.

6. The method of claim 1 wherein said customer selects said selection from an electronic catalog of said plurality of video products.

7. The method of claim 6, further comprising:
adding at least one additional video product to said plurality of video products on said retail purchase station via a command center.

8. The method of claim 7 wherein said adding step is performed electronically using a communication interface between said retail purchase station and said command center.

9. The method of claim 7 wherein said adding step is performed using a wireless communication between said retail purchase station and said command center.

10. The method of claim 7 wherein said adding step comprises updating said electronic catalog.

11. A system for producing selected video product at a point-of-sale in retail-reasonable time comprising:
a command center;
a purchase station coupled to said command center;
at least one video product in an electronic format coupled to said purchase station; and
a selection interface coupled to said purchase station.

12. The system of claim 11, further comprising:
a production unit coupled to said purchase station capable of producing said at least one video product in retail-reasonable time.

13. The system of claim 11 further comprising:
a storage unit for said at least one video product coupled to said purchase station.

14. The system of claim 11, further comprising:
a satellite interface coupled to said purchase station capable of receiving at least one video product.

15. A point-of-sale video product production system comprising:
a command center;
a purchase station;
communication means for providing at least one video product from said command center to said purchase station; and
a selection interface coupled to said purchase station.

16. The video product production system of claim 15, further comprising:
an electronic product catalog coupled to said purchase station;
communication means for updating said electronic product catalog remotely from said command center.

17. The video product production system of claim 15, further comprising:
searching means for said electronic product catalog coupled to said selection interface.
